(19) United States
(12) Patent Application Publication
(10) Pub. No.: US 2004/0232303 A1
(43) Pub. Date: Nov. 25, 2004

(54) Guide rail for the seat of a motor vehicle

(76) Inventors: Peter Rausch, Coburg (DE); Jochen Hofmann, Marktgraitz (DE); Christina Schwerdtner, Neustadt (DE); Bernd Hausler, Kirchardt (DE); Martin Rader, Coburg (DE); Sven Fischer, Witzmannsberg (DE)

Correspondence Address: CHRISTIE, PARKER & HALE, LLP, PO BOX 7068, PASADENA, CA, 91109-7068, US

(21) Appl. No.: 10/489,473

(22) PCT Filed: Sep. 11, 2002
(86) PCT No.: PCT/DE02/03474

(30) Foreign Application Priority Data
Sep. 13, 2001 (DE) 201 15 164.2

(51) Int. Cl. F16M 13/00

(52) U.S. Cl. 248/424

(57) ABSTRACT

The invention relates to a guide rail for the seat of a motor vehicle, comprising add-ons for the connection of a seat frame, a safety belt or the like. According to the invention, at least one part of the add-ons (2) are connected to the guide rail (1) by means of laser welding.

### CROSS-REFERENCE TO RELATED APPLICATION

This application is a National Phase Patent Application of International Application Number PCT/DE02/03474, filed on Sep. 11, 2002, which claims priority of German Patent Application Number 201 15 164.2, filed on Sep. 13, 2001.

### FIELD OF THE INVENTION

The invention relates to a guide rail for a motor vehicle seat with mountings for connecting a seat frame, seat belt or the like.

### BACKGROUND

Motor vehicle seats are known from DE 196 16 915 A1 and DE 197 15 626 A1 which, in order to fit a seat frame, use fixing angles or pipe-clip like component parts which in turn are fixed by screws or rivets. Fixing points of this kind have to transfer the forces which are caused in the event of a crash and which are in part extremely high, in a quasi punctiform manner and therefore have to be designed extremely solid. As a result of this a comparatively large amount of materials and structural space has to be used.

### SUMMARY

The object of the invention is to provide means for connecting mountings to guide rails of a motor vehicle seat which are characterised by a high load bearing capacity, the use of a minimum amount of material and an automated manufacturing process.

According to this at least one mounting is connected to the guide rail by laser welding. At least one part of the joining edges of the mounting which are provided to form the welding seam is prepared for laser welding; with stamped or cut highly-stressed mountings the smooth cut part is preferably at least 60 percent.

Laser welding has the advantage over other types of welding processes that the thermal strain on the guide rails and mountings is comparatively low so that negative effects such as heat distortion or excessive structural changes can be practically eliminated.

A particularly high mechanical load bearing capacity of mountings made from flat steel or the like can be achieved if the welding seam is provided on opposite edges of the mounting or on a circumferential edge of the mounting. The mountings which are to be fixed can be fitted obtusely on the surface of the guide rail or can be inserted in an opening of the lower rail before the welding seam is produced.

### BRIEF DESCRIPTION OF THE DRAWINGS

The invention will now be explained in further detail with reference to one of the embodiments and the drawings. In the drawings:

FIG. 1a shows a perspective exploded view of a guide rail and two mountings;

FIG. 1b shows a guide rail with mountings butt-welded on the surface of the guide rail;

FIG. 2 shows a guide rail with mountings inserted through slit-type openings and welded along the edge of the opening;

FIG. 3a shows a perspective exploded view of a guide rail and of two mountings with positive locking elements;

FIG. 3b is similar to FIG. 3a but with positively locking elements welded on.

### DETAILED DESCRIPTION

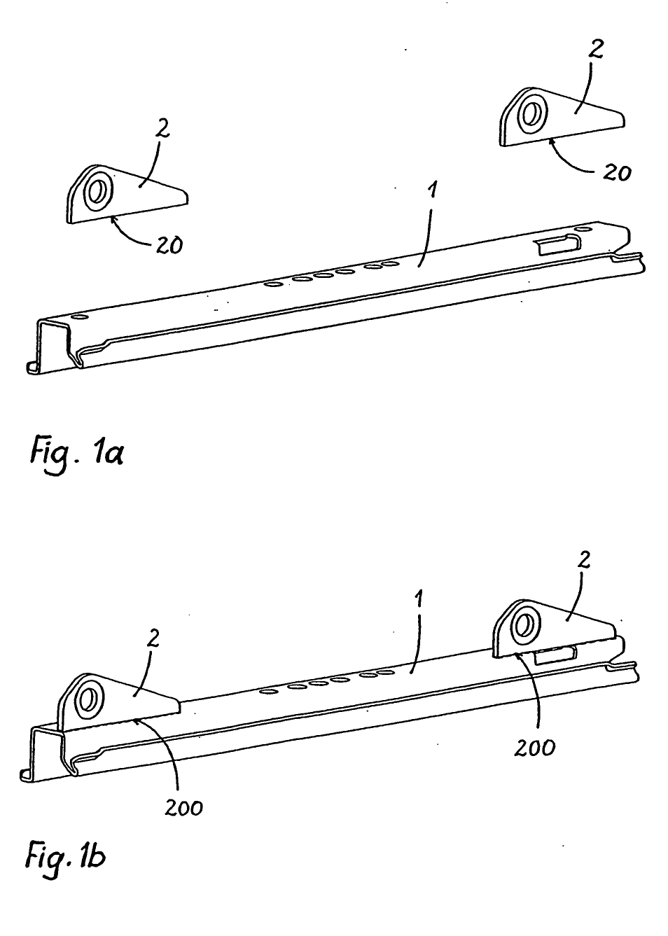

In the embodiment according to FIGS. 1a and 1b identical mountings 2 are used front and back for mounting the axes of the adjusting kinematics (not shown) and are fitted by their lower edges 20 obtusely on the surface of the guide rail 1. The welded seam 200 along the edges 20 extends on both sides of the mountings 2 which are made from flat steel. In order to ensure good quality and high load bearing capacity of the welded seam 200, which is designed as a fillet weld, the edge 20 has a smooth cut proportion of at least 60 percent.

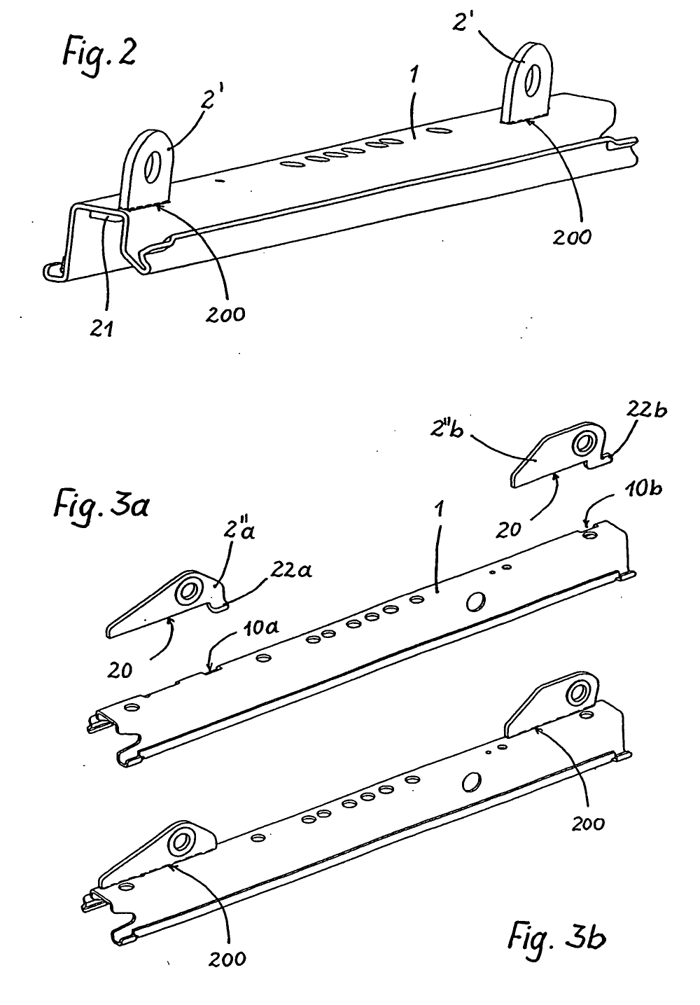

The embodiment shown in FIG. 2 has a guide rail 1 with slit like openings into which the vertical arms of an L-shaped mounting 2′ are inserted and fixed by means of a welded seam 200 extending along the edge of the slit like opening. The horizontal arm of the mounting 2′ functions as a stop 21 which is supported on the underneath of the guide rail. Through a preferably circumferentially welded seam 200 the slit like insert opening is practically closed again and thus no longer forms a weak spot in the guide rail 1.

According to the variation of FIGS. 3a and 3b mountings 2″a, 2″b are used which are fitted by one part (wedge 20) bluntly on the surface of the guide rail 1 and have an angled region 22a, 22b adjoining here. The angled regions 22a, 22b are associated with engagement openings 10a, 10b in the guide rail which also serve to provide a positive locking connection.

The high mechanical load bearing capacity of the laser-welded connections described also enables the integration of a stop point for a seat belt.

1. A guide rail for a motor vehicle seat with mountings for connecting a seat frame or a seat belt, wherein at least one part of the mountings is fitted by one region bluntly on a surface of the guide rail and is connected to the guide rail by laser welding.

2. A guide rail according to claim 1, wherein the one region has an abutment edge and at least a part of the abutment edge of the mounting provided for forming a welded seam is prepared for laser welding whereby a smooth cut proportion amounts to at least 60 percent.

3. The guide rail according to claim 1, wherein the welded seam is provided on opposite edges of the mounting.

4. The guide rail according to claim 1, wherein the welded seam is provided on a circumferential edge of the mounting.

5. (Cancelled)

6. The guide rail according to at least one of claims 1 to 4 wherein the mounting has an angled region adjoining the one region, and wherein an engagement opening is allocated to the angled region in the guide rail to produce a positive locking connection.

7. The guide rail according to claim 1 further comprising means integrated in the mounting for connecting a seat belt.

8. A method of making a guide rail with mountings for connecting a seat frame or a seat belt of a motor vehicle seat, comprising:
fitting at least one part of the mountings by one region bluntly on a surface of the guide rail; and
connecting the at least one part of the mountings to the guide rail by laser welding.

9. The method according to claim 8, wherein the one region has an abutment edge and at least a part of the abutment edge of the mounting provided for forming a welded seam is prepared for laser welding whereby a smooth cut proportion amounts to at least 60 percent.

10. The method according to claim 8, wherein the welded seam is provided on opposite edges of the mounting.

11. The method according to claim 8, wherein the welded seam is provided on a circumferential edge of the mounting.

12. The method according to at least one of claims 8 to 11 wherein the mounting has an angled region adjoining the one region, and wherein an engagement opening is allocated to the angled region in the guide rail to produce a positive locking connection.

13. The method according to claim 8 further comprising means integrated in the mounting for connecting a seat belt.
